(19) United States
(12) Patent Application Publication
(10) Pub. No.: US 2023/0397790 A1
(43) Pub. Date: Dec. 14, 2023

(54) METHOD AND COMMUNICATION SYSTEM FOR THE COUPLED OPERATION OF AN ELECTRIC SCRUBBING BRUSH AND AN ELECTRIC PUMP DEVICE

(71) Applicant: EINHELL GERMANY AG, Landau/Isar (DE)

(72) Inventor: Stefan MAYR, Landau/Isar (DE)

(21) Appl. No.: 18/330,048

(22) Filed: Jun. 6, 2023

(30) Foreign Application Priority Data
Jun. 9, 2022 (DE) 10 2022 114 570.0

(51) Int. Cl. A47L 11/40; A47L 11/282

(52) U.S. Cl. CPC A47L 11/4011; A47L 11/282; A47L 11/4005; A47L 11/4088

(57) ABSTRACT

According to a method for the coupled operation of an electric scrubbing brush (3), which is electrically operable by means of a first battery pack (1) and capable of being supplied with scrubbing liquid, and an electric pump device (4) for supplying the electric scrubbing brush (3) with the scrubbing liquid, wherein the electric pump device (4) is electrically operable by means of a second battery pack (2), an activation or change of an active operation of the electric scrubbing brush (3) is automatically detected and an activation signal is transmitted from the first battery pack (1) or from the electric scrubbing brush (3) depending thereon, which is received by the second battery pack (2) or by the electric pump device (4). Accordingly, an active operation of the electric pump device (4) is automatically activated or automatically changed depending on the received activation signal.

### FIELD

The present invention relates to a method and to a communication system for the coupled operation of an electric scrubbing brush, which is electrically operable by means of a first battery pack and capable of being supplied with scrubbing liquid, and an electric pump device for supplying the scrubbing brush with the scrubbing liquid, wherein the pump device is electrically operable by means of a second battery pack.

### BACKGROUND

In the operation of an electric scrubbing brush, which can be supplied with water by an electric pump, it can possibly be desirable that the pump adapts to the respective operation of the electric scrubbing brush to always provide the correct pressure or the correct amount of water. A turned on pump provides a water pressure, which is possibly not required. Thus, the pump unnecessarily consumes power and wears faster.

Pumps are already known, which provide water in automated manner. However, this principle is based on the fact that pumps controlled by pressure loss can determine a pressure loss in a pressure line, for example by opening a valve of the pressure line or by water withdrawal by means of the scrubbing brush from the pressure line, and the operation of the pump can accordingly be activated to maintain the pressure and to convey water. However, it is disadvantageous in these known pumps that the valve has to be opened first or the scrubbing brush has to withdraw water from the pressure line, such that water escapes from the pressure line and the pressure in the pressure line only drops as a result. Only as a result in turn the pump is activated after determining the pressure drop, whereafter water can be provided with a time offset. This indirect correlation between water withdrawal and the supply with water results in an undesired delay, which in particular adversely affects in using a scrubbing brush. A further disadvantage of the pumps controlled by pressure loss is in that they are always activated in case of pressure loss even if an activation is not desired at all. In particular, in case of leakage of the pressure line, the operation of the pump controlled by pressure loss becomes undesirably active such that water further leaks from the leakage. A further disadvantage is in that the operation of the pump controlled by pressure loss can be permanently active in case of a malfunction of a pressure sensor, which determines the pressure loss, which can result in a considerable energy demand and in an increased wear of the pump.

Furthermore, a pump is not known, which can respond to different operating modes of an electric scrubbing brush and can provide a corresponding water pressure or a corresponding amount of water for the electric scrubbing brush. This is in particular based on the fact that known pumps are operated independently of a requirement of a corresponding water pressure or a corresponding amount of water.

Therefore, it is the object of the present invention to specify an operation of an electric pump device, which operation directly responds depending on an operation of an electric scrubbing brush.

### SUMMARY

The object is solved by a respective subject matter of the independent claims. Advantageous developments and preferred embodiments are described in the dependent claims.

According to an aspect of the invention, a method for the coupled operation of an electric scrubbing brush, which is electrically operable by means of a first battery pack and capable of being supplied with scrubbing liquid, and an electric pump device for supplying the electric scrubbing brush with the scrubbing liquid, wherein the electric pump device is electrically operable by means of a second battery pack, is provided. The method includes the steps of automatically detecting an activation or change of an active operation of the electric scrubbing brush; transmitting an activation signal depending on the detected activation or the detected change from the first battery pack or from the electric scrubbing brush; receiving the activation signal by the second battery pack or by the electric pump device; and automatically activating or automatically changing an active operation of the electric pump device depending on the received activation signal.

Preferably, the electric scrubbing brush can serve for motor-assisted cleaning of surfaces, in particular of at least substantially flat floor surfaces, along which the cleaning appliance can be guided by a respective user. The electric scrubbing brush can comprise a motor compartment, in which an electric motor is arranged, as well as a battery receptacle electrically connected to the electric motor for receiving the first battery pack, which serves for electrical supply of the electric motor. A rotatably drivable shaft for receiving or holding at least one roller brush for cleaning the surfaces can be mechanically connected to the electric motor.

Furthermore, the electric scrubbing brush can comprise a connection for a hose or a line, in particular a water hose or a water line, wherein the scrubbing brush can be supplied with scrubbing liquid by the connection. The scrubbing liquid can be used by the scrubbing brush to moisturize or to wet the roller brush and/or the surface to be cleaned, over which the cleaning appliance can be guided, with the scrubbing liquid. Thereby, a scrubbing process can be facilitated or be allowed in the first place. In particular, the electric scrubbing brush can comprise a controllable or regulable valve, which adjusts the supply and/or the amount and/or the pressure of the scrubbing liquid to the roller brush or to the surface. The scrubbing liquid is preferably water, for example rain water from a rain barrel or cistern, or water from a body of water or water mixed with a cleaning agent.

Preferably, the electric pump device can serve for delivering or conveying the scrubbing liquid by motor. The electric pump device can comprise an electrically drivable pump as well as a battery receptacle electrically connected to the pump for receiving the second battery pack, which serves for electrical supply of the pump. In particular, the pump can include an electric motor, which can in particular be connected to an impeller for delivering the scrubbing liquid via a rotatable shaft.

Further, the electric pump device can comprise a connection for a further hose or a further line, wherein the scrubbing liquid can be delivered and provided by the connection. The electric pump device is in particular formed to deliver the scrubbing liquid, for example from a reservoir, in particular a rain barrel, a cistern, a pond or another body of water, through the connected hose or the connected line. In particular, a pump of the pump device can be virtually under water within the reservoir or be connected to the reservoir via a further hose outside of the reservoir. In particular, the delivered scrubbing liquid can be provided in a certain amount, for example indicated in liters per hour, and under a certain pressure. The electric pump device can for example be a submersible pump, a pumping system or a pumping station.

In performing the method according to the invention, the connection of the pump device is connected to the connection of the electric scrubbing brush via the hose or via the line such that the electric scrubbing brush can be supplied with scrubbing liquid by the electric pump device.

That the electric scrubbing brush and the electric pump device are each operable by means of the first and the second battery pack, respectively, can be understood such that they are each connectable to the respective battery pack and can be supplied with electrical energy by the corresponding battery pack. In performing the method according to the invention, the electric scrubbing brush is connected to the first battery pack and the electric pump device is connected to the second battery pack.

If the active operation of the electric scrubbing brush is activated, thus, this can be understood such that the electric scrubbing brush is first not in the active operation and is then correspondingly brought into the active operation. For example, the electric scrubbing brush is in a sleep mode or in a deactivated or inactive operation before the activation. In particular, the rotatable roller brush is stopped before the activation and/or the valve is closed such that a supply of scrubbing liquid is prevented.

In the active operation of the electric scrubbing brush, the roller brush can rotate and/or the valve can be opened in a certain valve position such that scrubbing liquid can be supplied.

If the active operation of the electric scrubbing brush is changed, thus, this can for example correspond to a change of one or more operating parameters of the operation of the electric scrubbing brush. These operating parameters can for example include: a rotational speed, a torque of the roller brush and/or the valve position for regulating the amount or the pressure of the scrubbing liquid.

The activation or change of the active operation of the electric scrubbing brush can be generally manually initiated, for example by the actuation of one or more control elements of the electric scrubbing brush for manual control, for example of a lever, switch, controller or the like, by a user. The activation or change of the active operation of the electric scrubbing brush can for example be detected by a sensor circuit of the scrubbing brush in that an actuation of the control element is detected. Alternatively or additionally, the activation of the active operation of the electric scrubbing brush can be detected in that an output of electrical energy from the first battery pack to the electric scrubbing brush is detected. Therein, the detection can thus be effected by the first battery pack alone or by capturing corresponding sensor signals by means of the first battery pack, wherein the sensor circuit, which captures the activation or the change and which generates the sensor signal depending on the activation or change, can be arranged within the first battery pack, but can also be outside of the first battery pack, in particular in the electric scrubbing brush. For example, the sensor signal can be transferred via the electrical connection of the first battery pack to the electric scrubbing brush.

In particular, the sensor signal can be further processed by a control unit of the first battery pack or of the electric scrubbing brush. In particular, the sensor circuit is connected to a first communication interface of the first battery pack or of the electric scrubbing brush in direct manner or via the control unit. The first communication interface is in particular formed to send the activation signal.

In particular, the activation signal can be indirectly or directly received by a second communication interface of the second battery pack or of the electric pump device.

The active operation of the electric pump device can be understood as such one, in which the electric pump device delivers the scrubbing liquid. Therein, the pump is in particular supplied with electrical energy by the second battery pack.

The activation or change of the active operation of the electric pump device is automatically effected, thus without action of a user being required hereto. Upon the activation, the electric motor of the electric pump device is preferably supplied with energy such that the scrubbing liquid is delivered and thus the electric scrubbing brush is supplied. Upon a change of the active operation, a rotational speed of the electric motor can for example be changed such that an amount or a pressure of the delivered scrubbing liquid can for example be changed.

The change of the active operation of the electric pump device is in particular adapted to the change of the active operation of the electric scrubbing brush. For example, the scrubbing brush is supplied with exactly that pressure and/or that amount of scrubbing liquid by the electric pump device, which the electric scrubbing brush requires in its active operation.

In particular, the activation of the active operation of the electric pump device is directly and automatically effected upon the activation of the active operation of the electric scrubbing brush. In particular, the specific change of the active operation of the electric pump device is directly and automatically effected upon the specific change of the active operation of the electric scrubbing brush.

In the active operation of the electric scrubbing brush and of the electric pump device, a battery housing of the corresponding battery pack is in particular respectively coupled or attached to a respective receptacle of the electric scrubbing brush and of the electric pump device, respectively. Therein, the respective battery pack is detachably, in particular non-destructively detachably, connected to the receptacle of the electric scrubbing brush and of the electric pump device, for example via a locking connection, a plug connection and/or a clamping connection. In particular, the mechanical connection of the respective battery pack to the receptacle can be configured as a form-fit and/or force-fit connection without a firmly bonded connection being present. In other words, the mechanical connection of the respective battery pack to the receptacle of the electric appliance can be detached without a firmly bonded connection having to be detached. Preferably, the mechanical connection can be manually detached without the employment of other tools as intended. In other words, the battery pack is configured as an exchangeable battery pack, in particular system battery pack. For electrical and mechanical connection, the housing of the battery pack and of the receptacle can comprise respective interfaces.

The electric connection can for example be effected via one or more plug contacts, in particular so-called tulip contacts or blade contacts. For example, plugs or sockets and receptacles, respectively, or the like each compatible with each other can be provided at the interfaces of the corresponding housings to achieve the electrical connection of the battery pack to the electric appliance.

On the one hand, the coupled operation of the electric scrubbing brush and of the electric pump device for supplying the scrubbing brush with the scrubbing liquid has the advantage that the scrubbing liquid is provided exactly when it is also required by the electric scrubbing brush. If scrubbing liquid is not required, scrubbing liquid also is not provided. Furthermore, exactly that amount or that pressure of scrubbing liquid can be provided by the electric pump device, which is required by the electric scrubbing brush. Thus, the electric pump device is not unnecessarily operated such that it can be protected. Thereby, wear of the pump device can in particular be reduced or a lifetime of the pump device can be increased. On the other hand, the scrubbing liquid is efficiently utilized because too much pressure or a too large amount of scrubbing liquid is not provided.

A further advantage is in that only the active operation of the scrubbing brush, which is controlled by the user for cleaning of a surface, has to be activated or changed, wherein the pump device automatically adapts to this activation or change and the user does not have to directly act on it. Thus, the control of the scrubbing brush is considerably simplified. A further advantage is in that the operation of the pump device is directly coupled to the operation of the scrubbing brush such that the supply of the scrubbing brush with scrubbing liquid by the pump device can be provided without time offset. The direct dependency of the operation of the pump device on the operation of the scrubbing brush furthermore offers the advantage that the pump device cannot be undesirably automatically operated, but only in the operation of the scrubbing brush.

Preferably, it is provided that the activation signal contains information about the electric scrubbing brush and/or information about the first battery pack. This information can for example serve for the identification of the electric scrubbing brush and/or of the first battery pack such that the activation signal can be uniquely associated with a sender. Furthermore, the activation signal can contain information about the activation of the active operation or the changed, active operation of the electric scrubbing brush, in particular about the required amount and the required pressure of scrubbing liquid, respectively.

By the activation signal, which contains said information, the electric pump device and the second battery pack, respectively, can advantageously uniquely associate the activation signal and thus correspondingly automatically activate or change the activated operation.

Preferably, it is provided that based on the information about the electric scrubbing brush and/or information about the first battery pack of the received activation signal, an association criterion is examined if the first battery pack and/or the electric scrubbing brush are associated with the second battery pack and/or the electric pump device.

If the activation signal has been transferred and in particular after the activation signal has been transferred, it can preferably be examined by means of a control unit of the second battery pack or of the electric pump device if the first battery pack and/or the first electric appliance are associated with the second battery pack and/or the second electric appliance according to the preset association criterion. This is in particular advantageous if the first battery pack and the electric scrubbing brush, respectively, are not or not yet coupled to the second battery pack and the electric pump device, respectively. For example, this can be the case if a first-time activation or first activation after a defined period of time is effected.

The association criterion is in that the first battery pack and/or the electric scrubbing brush are associated with the second battery pack and/or the electric pump device. An association can already exist if the respective battery packs and the scrubbing brush and the pump device, respectively, are suitable for a coupled operation. In particular, this can exist for an operation of an electric scrubbing brush and an electric pump device. In particular, this coupling is then automatically effected.

Preferably, an association criterion can also exist in that a coupling already existed in advance and it was correspondingly stored, preferably on the memory unit of the second battery pack or of the electric pump device. In particular, a user can set an association in suitable manner, for example via actuating elements of the electric scrubbing brush, of the electric pump device or of the first or second battery pack, or for example via a user interface on an external control device. The association can also depend on further conditions, which can for example also include the spatial position of the electric scrubbing brush to the electric pump device and so on.

By this method step, it can advantageously be ensured that the electric pump device is associated with the electric scrubbing brush. Thereby, the supply of the scrubbing brush with scrubbing water can be advantageously ensured.

Preferably, it is provided that the active operation of the electric pump device is only activated or changed if it is determined as a result of the examination that the association criterion is satisfied.

Thus, it is thereby achieved that the activation or change of the active operation of the electric pump device upon the activation of the electric scrubbing brush is only effected under certain conditions specified by the association such that a more selective, coupled operation becomes possible. Thereby, it can advantageously be achieved that an activation signal of a further electric appliance, which is not associated with the electric pump device, can result in an activation or change of the operation of the electric pump device. Thus, a reliable and safe, coupled operation can be advantageously ensured.

Preferably, the examination of the association criterion and the activation or change of the operation of the electric pump device depending thereon only occurs if a coupling in terms of signal is not yet present.

Otherwise, it is preferably provided that the active operation of the pump device is only activated or changed if the first battery pack is associated with the second battery pack and/or the electric pump device by a coupling in terms of signal or if the electric scrubbing brush is associated with the second battery pack and/or the electric pump device by a coupling in terms of signal.

A coupling in terms of signal can be a direct coupling, for example a Bluetooth connection or a connection by means of another radio standard, or an indirect coupling, for example via a network interface. Correspondingly, the activation signal can be transmitted and received via the coupling in terms of signal such that the examination of an association criterion preferably cannot be required. Thus, a reliable and safe, coupled operation can advantageously be ensured.

Preferably, it is provided that the activation signal is transmitted to the second battery pack or the electric pump device via a wireless and direct communication connection.

For example, the activation signal is a radio signal of a direct coupling in terms of signal, thus for example a radio signal of a Bluetooth connection. In particular, a point-to-point connection can be understood by the direct communication connection. Hereby, the advantage arises that external interfaces are not required such that the transmission of the activation signal can be fast and reliably effected.

Alternatively, it can preferably be provided that the activation signal is transmitted to the second battery pack or the electric pump device via a wireless and indirect communication connection, wherein the indirect communication connection is established via a local network or an external server computer unit. In particular, a server computer unit is referred to as external, which is external to the battery packs and external to the electric scrubbing brush and the electric pump device.

A local network can for example be a WLAN network, in which the first battery pack and/or the electric scrubbing brush, and the second battery pack and/or the electric pump device are registered, wherein the activation signal can be transmitted via a network router of the WLAN network. Alternatively, the indirect communication connection can be established via an external server computer unit. The connection to the external server computer unit can for example be effected via the Internet by means of mobile radio or by means of the network router. An indirect communication connection can be advantageous to the effect that a range, in which the activation signal can be transmitted and received, can be greater than in case of a direct communication connection. Thus, the electric pump device can be positioned independently of a position of the electric scrubbing brush.

A further advantage can be in that further services can be provided for the user via the network router or the external server computer unit, for example in an application on a computer or a mobile terminal. Here, association criteria can for example be defined by the user.

Preferably, it is provided that the activation or the change of the active operation of the electric scrubbing brush is initiated by a user input.

The activation signal is transferred in response to the captured user input, thus in particular only if the user input has been effected and captured, or the active operation of the electric scrubbing brush is only activated or changed if the user input has been captured.

In the latter case, the information that the user input has been captured, can for example be transferred as part of the information of the activation signal.

If the second battery pack or the electric pump device captures the user input, thus, the second battery pack or the second electric appliance can transfer corresponding information to the first battery pack or the first electric appliance, which can then correspondingly transfer the activation information as described after the activation of the first electric appliance.

The user input can for example be captured by the actuation of corresponding knobs, buttons, touch-sensitive displays or also via a voice input.

Preferably, it is provided that a deactivation of the active operation of the electric scrubbing brush is automatically captured and a deactivation signal is transmitted from the first battery pack or from the electric scrubbing brush depending on the detected deactivation, wherein the second battery pack or the electric pump device receives the deactivation signal and automatically deactivates the active operation of the electric pump device after a presettable period of time depending on the received deactivation signal.

The deactivation of the active operation of the electric scrubbing brush can for example be initiated by releasing one of the actuating elements or by actively setting one of the actuating elements into an off position. The deactivation can also be initiated in that the first battery pack is discharged or the first battery pack and/or the electric scrubbing brush have a disorder, which prevents the active operation. From it, the advantage arises that the active operation of the electric pump device is not maintained longer than required such that energy can be saved and the pump device can be protected.

Preferably, it is provided that the second battery pack or the electric pump device transmits a status signal depending on a status of the second battery pack and/or of the electric pump device to the associated first battery pack or the associated scrubbing brush.

A status of the second battery pack can for example be a state of charge or a remaining utilization time of the second battery pack. Furthermore, the status of the second battery pack can be an error status based on a disorder of the second battery pack. A status of the electric pump device can in particular be an operating status, for example a relative power with respect to a maximum power, or an error status or the like.

Preferably, the status signal can be output for the user in suitable manner, for example on a display of the scrubbing brush, on a mobile terminal or by a LED of the scrubbing brush or the like. Thus, the user can be advantageously informed about the status of the second battery pack and/or the electric pump device.

According to a further aspect of the invention, a communication system for the coupled operation of an electric scrubbing brush, which is electrically operable by means of a first battery pack and can be supplied with scrubbing liquid, and an electric pump device for supplying the electric scrubbing brush with the scrubbing liquid, wherein the electric pump device is electrically operable by means of a second battery pack, is also provided.

The communication system comprises a sensor circuit for the first battery pack or for the electric scrubbing brush. The sensor circuit is configured to automatically detect an activation or change of an active operation of the electric scrubbing brush. Furthermore, the communication system comprises a first communication interface for the first battery pack or for the electric scrubbing brush, wherein the first communication interface is connected to the sensor circuit and configured to transmit an activation signal depending on a detection of the activation or change. Furthermore, the communication interface comprises a second communication interface for the second battery pack or for the electric pump device, wherein the second communication interface is configured to receive the activation signal. Furthermore, the communication interface comprises a control unit for the second battery pack or for the electric pump device, which is connected to the second communication interface and configured to automatically activate or automatically change an active operation of the electric pump device depending on the received activation signal.

Preferably, it is provided that the second communication interface is configured to directly receive the activation signal from the first communication interface. This is for example effected via a direct radio signal, wherein the first communication interface is the transmitter and the second communication interface is the receiver.

Preferably, it is provided that the communication system comprises a local network router or a server computer unit, wherein the local network router or the server computer unit is configured to receive the activation signal from the first communication interface and to transmit the activation signal to the second communication interface. The sever computer unit can also be referred to as cloud computing unit.

Preferably, it is provided that the communication device comprises a first memory unit for the first battery pack or for the electric scrubbing brush, which stores information about the first battery pack and/or the electric scrubbing brush.

In particular, the first battery pack can recognize the electric scrubbing brush when they are connected to each other, such that this information is stored on the first memory card. In particular, the electric scrubbing brush can recognize the first battery pack when they are connected to each other, such that this information is stored on the first memory card.

In particular, it can also be provided that the first memory unit stores information about the second battery pack or the electric pump device. In particular, this is the case if a coupling in terms of signal has already once before existed. Thereby, the association can be ensured in simplified manner for each further coupled operation.

Preferably, it is provided that the communication device comprises a second memory unit for the second battery pack or for the electric pump device, wherein the second memory unit stores information about the first battery pack and/or the electric scrubbing brush.

Further embodiments of the communication system according to the invention directly follow from the different forms of configuration of the method according to the invention and vice versa. In particular, a communication system according to the invention can be configured for executing a method according to the invention or can execute such a method.

### BRIEF DESCRIPTION OF THE FIGURES

Further features of the invention are apparent from the claims, the figures and the description of figures. The features and feature combinations mentioned above in the description as well as the features and feature combinations mentioned below in the description of figure and/or shown in the figure can be encompassed by the invention not only in the respectively specified combination, but also in other combinations. In particular, implementations and feature combinations are also encompassed by the invention, which do not comprise all of the features of an originally formulated claim. Moreover, implementations and feature combinations are encompassed by the invention, which extend beyond or deviate from the feature combinations set forth in the relations of the claims. In the following, the invention is explained in more detail based on specific embodiments and associated schematic drawings.

FIG. 1 shows a schematic representation of an exemplary embodiment of a communication system according to the invention.

### DETAILED DESCRIPTION

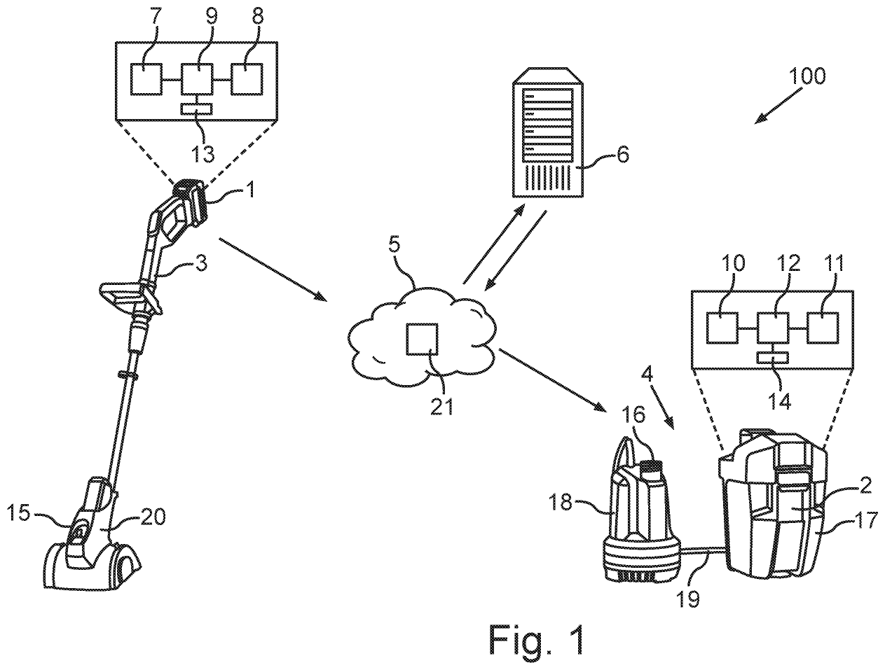

In the example shown in the FIG. 1, the communication system 100 comprises at least a first battery pack 1 and a second battery pack 2, which each contain at least one battery cell. Further, the communication system 100 can include an electric scrubbing brush 3 with the first battery pack 1, as well as a pump device 4 with the second battery pack 4. The pump device 4 can in particular include a pump 18 for immersing into a rain barrel, into a cistern or into a body of water, as well as a housing 17 for receiving the second battery pack 2, wherein the pump 18 and the housing 17 can be connected to each other via a power cable 19. A first connection 15 for supplying the scrubbing brush 3 with scrubbing liquid can be connected to a second connection 16 of the pump device 4 with a garden hose or the like not shown here.

The communication system 100 for example includes the first battery pack 1 and the second battery pack 2. In some embodiments, the communication system 100 can additionally include a server computer unit 6, also referred to as cloud or Internet of Things cloud or IoT cloud, as well as a local network 5 with a network router 21.

The first battery pack 1 can be fitted onto the electric scrubbing brush 3 at a corresponding receptacle and serve for electrical supply of an electric motor 20 of the scrubbing brush 3. The second battery pack 2 is in particular identical in construction to the first battery pack 1 and can be connected to the pump device 4 at a corresponding receptacle within the housing 17. The second battery pack 2 can serve for electrical supply of the pump 18.

In the shown example, the first battery pack 1 comprises a first sensor circuit 7, a first communication interface 8, a first control unit 9 as well as a first memory unit 13, which are each connected to each other to exchange signals.

The first sensor circuit 7 is formed to automatically detect an activation or change of an active operation of the electric scrubbing brush 3 and to correspondingly generate a first sensor signal. The generated sensor signal can be received and processed by the first control unit 9, which can be connected to the first sensor circuit 7. The first control unit 9 can generate an activation signal depending on the sensor signal and transmit it via the first communication interface 8, which can be connected to the first control unit 9.

In the shown example, the activation signal can be transmitted to a local network 5, preferably via a WLAN connection at a network router 21 of the local network 5. Respective transmission paths of the activation signal are illustrated by arrows in the shown FIG. 1. For example, the activation signal can be further processed and be transmitted to a server computer unit 6 via the Internet. The activation signal can in turn be further processed by the server computer unit 6 and be transmitted to the second battery pack 2 via the network router 21. However, other communication paths are also possible, for example via a direct coupling of the first battery pack 1 to the second battery pack 2 in terms of signal, or only via the local network 5.

The communication of the scrubbing brush 3, the pump device 4 or the battery packs 1, 2 with each other and/or with the server computer unit 6 can for example be effected according to various IoT technologies, for example as an IoT communication based on carrier network or via local distance networks. For the IoT communication based on carrier network, cell-based approaches, such as for instance GSM, UMTS, LTE, 5G, NB-IoT, or non-cell-based approaches such as for instance LoRa, ZigBee, are considered. WLAN or Bluetooth are to be mentioned as examples for local distance networks.

In particular, the server computer unit 6 and/or the second control unit 12 can examine the received activation signal with regard to an association criterion, namely if the first battery pack 1 and/or the electric scrubbing brush 3 are associated with the second battery pack 2 and/or the electric pump device 4.

In the shown example, the second battery pack 2 comprises a second sensor circuit 11, a second communication interface 10, a second control unit 12 as well as a second memory unit 14, which are each connected to each other to exchange signals. The second communication interface can receive the activation signal and pass it to the second control unit 12. Depending on the received activation signal, an active operation of the electric pump device 4 can be automatically activated and changed by the second control unit 12.

In order to activate the pump device 4, in particular the pump 18, or alternatively to activate, modify or adapt the active operation, the second battery pack 2, in particular the second control unit 12, is for example capable of selectively switching on and off the main current path to the pump 18 and/or of controlling or regulating the main current path based on voltage or based on power. The second battery pack 2, in particular the second control unit 12, can also be capable of recognizing and measuring a current draw and of using corresponding measurement values for the control or regulation.

For example, the battery packs 1, 2 can communicate with the respective electric appliance 3, 4 to get to know or evaluate information about the respective electric appliance 3, 4, preferably about the identity thereof, and/or to forward it to the server computer unit 6. The battery packs can for example also adjust the operation of the respective electric appliance 3, 4 via this communication.

The first memory unit 13 can in particular contain information about the electric scrubbing brush 3 and/or information about the first battery pack 1, wherein this information can be a constituent of the activation signal.

In particular, the second memory unit 14 can contain information about the electric pump device 4 and/or information about the second battery pack 2, wherein the received information about the connected electric scrubbing brush 3 and/or the received information about the connected first battery pack 1 can additionally be stored. In particular, the received information can be examined based on the association criterion if it is associated with the second battery pack 2 and/or the pump device 4. The association can for example correspond to modeling of an application network. Hereto, there are various possibilities. For example, a pairing mode or multi-pairing mode can be realized. For example, a dependent second battery pack or a second triggering battery pack or also the scrubbing brush of a dependent pump device can be registered at a battery pack.

The scrubbing brush 3 and/or the pump device 4 can also be capable of being supplied with energy by respectively multiple battery packs. In this case, it is not required that multiple battery packs of the same electric appliance are involved in the communication for association.

The registration of the scrubbing brush, the pump device or the battery packs can for example be implemented via a user interface. Therein, the use interface can for example include knobs or buttons, touchscreens, voice recognition interfaces or voice reproduction interfaces and so on. Therein, an advantage is in that the pairing is simply and inexpensively implementable for instance via WLAN or Bluetooth without a cloud having to be necessarily involved.

In more complex variants, the application model can be configured in the cloud. Hereto, a user interface can for example be implemented via web forms, web applications, mobile applications or so-called intelligent personal assistants. In addition, it can be determined, which electric appliances or battery packs are associated with a certain user, which individual electric appliances have been associated with each other, which appliance types are associated with each other and so on. Thus, a network of electric appliances and/or batteries cooperating with each other can be realized.

### LIST OF REFERENCE CHARACTERS

1 first battery pack
2 second battery pack
3 electric scrubbing brush
4 electric pump device
5 local network
6 external server computer unit
7 first sensor circuit
8 first communication interface
9 first control unit
10 second communication interface
11 second sensor circuit
12 second control unit
13 first memory unit
14 second memory unit
15 first connection
16 second connection
17 housing
18 pump
19 current cable
20 motor
21 network router
100 communication system

1. A method for the coupled operation of an electric scrubbing brush, which is electrically operable by a first battery pack and capable of being supplied with scrubbing liquid, and an electric pump device for the supply of the electric scrubbing brush with the scrubbing liquid, wherein the electric pump device is electrically operable by a second battery pack, the method comprising the steps:
automatically detecting an activation or change of an active operation of the electric scrubbing brush;
transmitting an activation signal depending on the detected activation or the detected change from the first battery pack or from the electric scrubbing brush;
receiving the activation signal by the second battery pack or by the electric pump device; and
automatically activating or automatically changing an active operation of the electric pump device depending on the received activation signal.

2. The method according to claim 1, wherein the activation signal contains information about the electric scrubbing brush and/or information about the first battery pack.

3. The method according to claim 2, wherein based on the information about the electric scrubbing brush and/or information about the first battery pack of the received activation signal, an association criterion is examined if the first battery pack and/or the electric scrubbing brush are associated with the second battery pack and/or with the electric pump device.

4. The method according to claim 3, wherein the active operation of the electric pump device is only activated or changed if it is determined as a result of the examination that the association criterion is satisfied.

5. The method according to claim 1, wherein the active operation of the pump device is only activated or changed if
the first battery pack is associated with the second battery pack and/or with the electric pump device by a coupling in terms of signal; or
the electric scrubbing brush is associated with the second battery pack and/or with the electric pump device by a coupling in terms of signal.

6. The method according to claim 1, wherein the activation signal is transmitted to the second battery pack or the electric pump device via a wireless and direct communication connection.

7. The method according to claim 1, wherein the activation signal is transmitted to the second battery pack or the electric pump device via a wireless and indirect communication connection, wherein the indirect communication connection is established via a local network or an external server computer unit.

8. The method according to claim 1, wherein
the activation or the change of the active operation of the electric scrubbing brush is initiated by a user input.

9. The method according to claim 1, wherein a deactivation of the active operation of the electric scrubbing brush is automatically captured and a deactivation signal is transmitted from the first battery pack or from the electric scrubbing brush depending on the detected deactivation, and wherein the second battery pack or the electric pump device receives the deactivation signal and automatically deactivates the active operation of the electric pump device after a presettable period of time depending on the received deactivation signal.

10. The method according to claim 5, wherein the second battery pack or the electric pump device transmits a status signal depending on a status of the second battery pack and/or of the electric pump device to the associated first battery pack or the associated scrubbing brush.

11. A communication system for the coupled operation of an electric scrubbing brush, which is electrically operable by a first battery pack and capable of being supplied with scrubbing liquid, and an electric pump device for supplying the electric scrubbing brush with the scrubbing liquid, wherein the electric pump device is electrically operable by a second battery pack, the communication system comprising:
a sensor circuit for the first battery pack or for the electric scrubbing brush, which is configured to automatically detect an activation or change of an active operation of the electric scrubbing brush;
a first communication interface for the first battery pack or for the electric scrubbing brush, wherein the first communication interface is connected to the sensor circuit and configured to transmit an activation signal depending on a detection of the activation or change;
a second communication interface for the second battery pack or for the electric pump device, wherein the second communication interface is configured to receive the activation signal; and
a control unit for the second battery pack or for the electric pump device, which is configured to automatically activate or automatically change an active operation of the electric pump device depending on the received activation signal.

12. The communication system according to claim 11, wherein the second communication interface is configured to receive the activation signal directly from the first communication interface.

13. The communication system according to claim 11, comprising a local network router or a server computer unit, wherein the local network router or the server computer unit is configured receive the activation signal from the first communication interface and to transmit the activation signal to the second communication interface.

14. The communication system according to claim 1, comprising a first memory unit for the first battery pack or for the electric scrubbing brush, which stores information about the first battery pack and/or the electric scrubbing brush.

15. The communication system according to claim 1, comprising a second memory unit for the second battery pack or for the electric pump device, wherein the second memory unit stores information about the first battery pack and/or the electric scrubbing brush.
